(19) United States
(12) Patent Application Publication
(10) Pub. No.: US 2015/0116606 A1
(43) Pub. Date: Apr. 30, 2015

(54) TOUCH SCREEN SENSING DEVICE, METHOD FOR MANUFACTURING THE SAME, AND TOUCH SCREEN SENSING ASSEMBLY HAVING THE SAME

(71) Applicant: SHENZHEN CHINA STAR OPTOELECTRONICS TECHNOLOGY CO., LTD., Shenzhen, Guangdong (CN)

(72) Inventor: Yuan Xiong, Shenzhen (CN)

(73) Assignee: SHENZHEN CHINA STAR OPTOELECTRONICS TECHNOLOGY CO., LTD., Shenzhen, Guangdong (CN)

(21) Appl. No.: 14/130,498

(22) PCT Filed: Nov. 13, 2013
(86) PCT No.: PCT/CN2013/087077

§ 371 Date: Jan. 2, 2014

(30) Foreign Application Priority Data
Oct. 30, 2013 (CN) 201310530073.7

(51) Int. Cl. G06F 3/044; G02F 1/1339; G02F 1/1333; G02F 1/1362

(52) U.S. Cl. CPC G06F 3/044; G02F 1/1362; G02F 1/13394; G02F 1/133345; G02F 2001/136222; G02F 2201/121; G02F 2201/123
USPC 349/12; 216/6

(57) ABSTRACT

The present disclosure provides a touch screen sensing device, a method for manufacturing the same, and a touch screen sensing assembly having the same. The touch screen sensing device includes a COA structure including a TFT and a multilayer color film configured on the TFT, a common electrode located above the COA structure and corresponding to an upper portion of the multilayer color film, a capacitor electrode configured between the common electrode and the COA structure, and a spacer configured between the common electrode and the COA structure to space the lateral section from the capacitor electrode. The capacitor electrode includes a lateral section located on an upper portion of the multilayer color film and an extending section extending from one end of the lateral section and covering a side portion of the multilayer color film.

### BACKGROUND

1. Technical Field

The present disclosure relates to technologies of liquid display, and more particularly, to a touch screen sensing device, a method for manufacturing the same, and a touch screen sensing assembly having the same.

2. Description of Related Art

A sensing device applied in the capacitive touch screen technology requires a sensing capacitor for determining the location of the touch. The sensing capacitor is configured in exterior of a display panel of a capacitive touch screen device. However, a thickness of the capacitive sensitive device is increased by configuring the sensing capacitor in this way. Meanwhile, the touch effect of the capacitive sensitive device is easily reduced due to changes of the outer environment.

### SUMMARY

The main object of the present disclosure is to provide a touch screen sensing device and a method for manufacturing the same for increasing a pixel aperture ratio of a capacitive touch screen sensing device and further improves a display effect of the capacitive touch screen sensing device.

The touch screen sensing device provided in the present disclosure including: a COA structure including a TFT and a multilayer color film configured on the TFT;

a common electrode located above the COA structure and corresponding to an upper portion of the multilayer color film;

a capacitor electrode configured between the common electrode and the COA structure, including a lateral section located on the upper portion of the multilayer color film and an extending section extending from one end of the lateral section and covering a side portion of the multilayer color film; and

a spacer formed between the common electrode and the COA structure to space the lateral section from the capacitor electrode.

Preferably, an insulating layer is arranged between the multilayer color film and the capacitor electrode.

Preferably, an insulating layer is arranged on the capacitor electrode.

Preferably, the multilayer color film includes a first color film, a second color film, and a third color film overlaying on the TFT in sequence; the extending section includes an inclined section and a protruding section, the inclined section corresponds to the third color film and the second color film, and the protruding section extends from the inclined section and covers a surface of the first color film.

Preferably, the COA structure further includes a pixel area arranged in parallel with TFT; a surface of the pixel area is provided with a pixel electrode, and the pixel electrode is electrically disconnected from the capacitor electrode.

The method for manufacturing a touch screen sensing device with a COA structure which includes a TFT and a multilayer color film configured on the TFT, including:

coating conductive material on a substrate with the COA structure formed thereon;

coating a photoresist on the conductive material and exposing the substrate with the photoresist coated thereon;

developing the exposed substrate and etching the developed substrate;

stripping the photoresist from the etched substrate and thus a capacitor electrode on the multilayer color film is formed wherein the capacitor electrode includes a lateral section located between an upper portion of the multilayer color film and the common electrode and an extending portion extending from one end of the lateral section and covering a side portion of the multilayer color film;

coating optical spacing material on a substrate with a common electrode formed thereon; and

exposing the substrate with the optical spacing material coated thereon and developing the exposed substrate to form a spacer on the common electrode which spaces the lateral section from the capacitor electrode.

Preferably, the method further includes the following step before the step of coating a photoresist on the conductive material and exposing the substrate with the photoresist coated thereon:

coating insulating material on the substrate with the conductive material coated thereon to form an insulating layer on the capacitor electrode; and

coating conductive material on the insulating layer.

Preferably, the method of claim further includes the following step after the step of stripping the photoresist from the etched substrate and thus a capacitor electrode on the multilayer color film is formed wherein the capacitor electrode includes a lateral section located between an upper portion of the multilayer color film and the common electrode and an extending portion extending from one end of the lateral section and covering a side portion of the multilayer color film:

coating insulating material on the substrate with the capacitor electrode formed thereon to form an insulating layer on the capacitor electrode.

Preferably, the multilayer color film includes a first color film, a second color film, and a third color film overlaying on the TFT in sequence; the extending section includes an inclined section and a protruding section, the inclined section corresponds to the third color film and the second color film, and the protruding section extends from the inclined section and covers a surface of the first color film.

Preferably, the COA structure further includes a pixel area arranged in parallel with TFT; a surface of the pixel area is provided with a pixel electrode, and the pixel electrode is electrically disconnected from the capacitor electrode.

The present disclosure further provides a touch screen sensing assembly, including:
a touch screen sensing device, including:
   a COA structure including a TFT and a multilayer color film configured on the TFT;
   a common electrode located above the COA structure and corresponding to an upper portion of the multilayer color film;
   a capacitor electrode configured between the common electrode and the COA structure, including a lateral section located on an upper portion of the multilayer color film and an extending from at least one end of the lateral section and covering a side portion of the multilayer color film; and
   a spacer configured between the common electrode and the COA structure to space the lateral section from the capacitor electrode; and
a backlight module emitting light which emits out after passing through the touch screen sensing device.

Compared to the conventional touch screen sensing device, the lateral section of the capacitor electrode and the common electrode forms a sensing capacitor of the touch screen sensing device, which increases the pixel aperture ratio of the capacitive touch screen sensing device and further improves the display effect of the capacitive touch screen sensing device.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view illustrating a touch screen sensing device in accordance with an embodiment of the present disclosure; and

FIG. 2 is a flow chart of a method for manufacturing the touch screen sensing device in accordance with an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

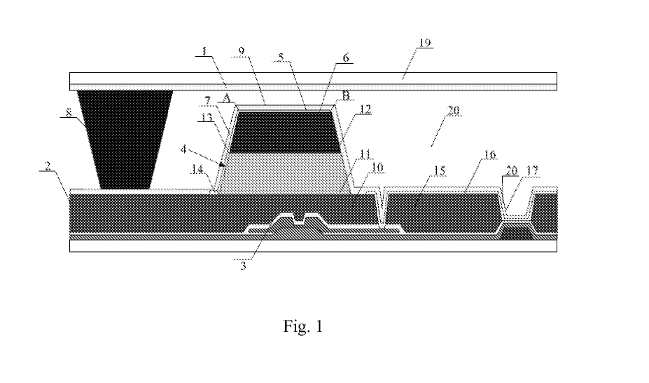

Referring to FIG. 1, which is a schematic view illustrating a touch screen sensing device in accordance with an embodiment of the present disclosure. The touch screen sensing device is given in detail as follows.

Referring to FIG. 1, the touch screen sensing device includes a common electrode 1 and a COA structure 2. The common electrode 1 is located above the COA structure 2. The COA structure 2 includes a TFT 3 and a multilayer color film 4 configured on the TFT 3. The common electrode 1 corresponds to an upper portion of the multilayer color film 4. A capacitor electrode 5 is configured between the common electrode 1 and the COA structure 2. The capacitor electrode 5 includes a lateral section 6 located on the upper portion of the multilayer color film 4 and an extending section 7 extending from at least one end of the lateral section 6 and covering a side portion of the multilayer color film 4. A spacer 8 is arranged between the common electrode 1 and the COA structure 2, spacing the common electrode 1 from the capacitor electrode 5. In this way, when the touch screen sensing device is touched, a short circuit of a sensing capacitor caused by an outer force can be avoided. An insulating layer 9 is arranged between the multilayer color film 4 and the capacitor electrode 5, in which the insulating layer may be optionally arranged on the capacitor electrode 5. The extending section 7 of the capacitor electrode 5 can extend from an end A of the lateral section 6 or from an end B of the lateral section 6, or from both the ends A and B of the lateral section 6.

Furthermore, the multilayer color film 4 includes a first color film 10, a second color film 11, and a third color film 12 overlaying on the TFT 3 in sequence. The extending section 7 includes an inclined section 13 corresponding to the third color film 11 and the second color film 11 and a protruding section 14 extending from the inclined section 13 and covering a surface of the pixel area 12.

The lateral section 6 of the capacitor electrode 5 and the common electrode 1 forms the sensing capacitor of the touch screen sensing device, which increases a pixel aperture ratio of a capacitive touch screen sensing device and further improves a display effect of the capacitive touch screen sensing device.

Furthermore, the COA structure 2 includes a pixel area 15 arranged in parallel with the TFT 3. A surface of the pixel area 15 is provided with a pixel electrode 16 which is electrically disconnected from the capacitor electrode 5. A storage capacitor 17 is configured on the TFT-side substrate, and a pole 18 of the storage capacitor 17 is electrically connected to the pixel electrode 16. The capacitor electrode 5 is electrically disconnected from the pixel electrode 16, which prevents the storage capacitor 17 from being influenced in the touch operation and thus improves the display effect of the touch screen sensing device.

Furthermore, the common electrode 1 is coated on another glass substrate 17 and liquid crystals (not shown) are ejected into a space defined between the common electrode 1 and the protruding section 14 of the capacitor electrode 5 to form a liquid crystal layer 20. Light from a backlight source (not shown) enters into the liquid crystal layer 20 between the common electrode 1 and the pixel area 15 after passing through the pixel area 15 and thereafter emits out of the liquid crystal layer 20 through the common electrode 1.

Furthermore, in order to provide good insulation between the capacitor electrode 5 and the common electrode 1, the insulating layer 9 is preferably made of SiNx. In other embodiments, the insulating layer 9 can be made of other suitable material.

Furthermore, in order to reduce the influence on the light transmittance of the touch screen sensing device, the capacitor electrode 5 is preferably made of transparent conductive material such as indium tin oxide (ITO) or indium zinc oxide (IZO). In other embodiments, the capacitor electrode 5 can be made of other suitable conductive material.

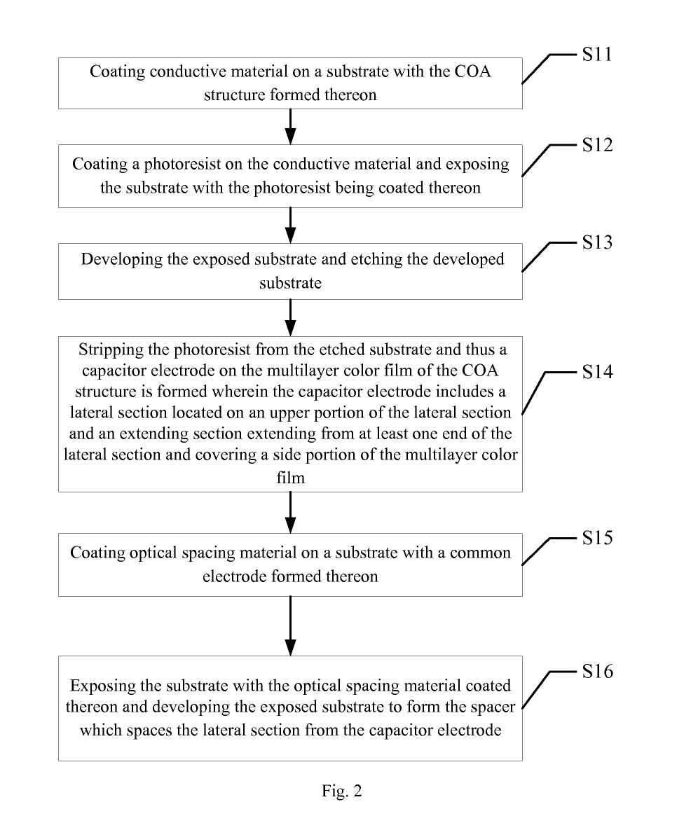

The present disclosure further provides a method for manufacturing a touch screen sensing device. Referring to FIG. 2, which is a flow chart of the method for manufacturing the touch screen sensing device, the touch screen sensing device includes a COA structure, and the COA structure includes a TFT and a multilayer color film configured on the TFT. The method is given in detail as follows.

Step S11, coating conductive material on a substrate with the COA structure formed thereon.

Step S12, coating a photoresist on the conductive material and exposing the substrate with the photoresist being coated thereon.

Step S13, developing the exposed substrate and etching the developed substrate.

Step S14, stripping the photoresist from the etched substrate and thus a capacitor electrode on the multilayer color film of the COA structure is formed wherein the capacitor electrode includes a lateral section located on an upper portion of the lateral section and an extending section extending from at least one end of the lateral section and covering a side portion of the multilayer color film.

Step S15, coating optical spacing material on a substrate with a common electrode formed thereon.

Step S16, exposing the substrate with the optical spacing material coated thereon and developing the exposed substrate to form the spacer which spaces the lateral section from the capacitor electrode.

Specifically, in the embodiment, the method can further include a step of coating insulating material on the substrate with the COA structure formed thereon to form an insulating layer, and the step may specifically be: coating the insulating material on the substrate with the COA structure formed thereon and curing the coated insulating material to form the insulating layer on the capacitor electrode. The insulating material can be cured by baking or ultraviolet light.

The step of forming the capacitor electrode between the common electrode and the COA structure specifically includes: coating the conductive material and the photoresist on the substrate with the COA structure formed thereon in sequence; irradiating special areas of the substrate with the conductive material and the photoresist coated thereon in sequence with a special photomask, that is, exposing the substrate with the conductive material and the photoresist coated thereon in sequence; and developing the exposed substrate to form the capacitor electrode between the common electrode and the COA structure.

The optical spacing material is coated on the substrate with the common electrode formed thereon. The substrate with the coated optical spacing material is exposed and the exposed substrate is thereafter developed to form the spacer on the common electrode. In this way, the spacer is formed between the lateral section and the capacitor electrode. A height of the spacer is determined by the touch screen sensing device. By forming the spacer between the common electrode and the COA structure, the common electrode is spaced from the capacitor electrode. In this way, when the touch screen sensing device is touched, a short circuit of a sensing capacitor of the touch screen sensing device caused by an outer force can be avoided. It is noted that the steps S15 and S16 can be implemented before or after any one of the steps from the step S11 to the step S14 is implemented.

The special photomask is opened at special positions according to the property of the photoresist. If the photoresist is a negative photoresist, the part of the photoresist which corresponds to the opened area of the photomask and is exposed to the ultraviolet light is not developed. If the photoresist is a positive photoresist, the part of the photoresist which corresponds to the opened area and is exposed to the ultraviolet light is developed.

In an embodiment of the present disclosure, if the photoresist is a negative photoresist, the photomask is opened at positions corresponding to the lateral section and the extending section. If the photoresist is positive photoresist, the photomask is opened at positions which do not correspond to the lateral section and the extending section. The capacitor electrode formed in this way includes the lateral section and the extending section. The lateral section is located on the upper portion of the multilayer color film, and the extending section extends from one end of the lateral section and covers the side portion of the multilayer color film. In other embodiments, the insulating layer can be formed on the capacitor electrode and then the step of forming the insulating layer on the capacitor electrode correspondingly includes: coating the insulating material on the substrate with the capacitor electrode formed thereon, curing the coated insulating material to form the insulating layer on the capacitor electrode. The insulating material can be cured by baking or ultraviolet light.

The multilayer color film includes a first color film, a second color film, and a third color film overlying on the TFT 3 in sequence. The extending section includes an inclined section corresponding to the second and third color films and a protruding section extending from the inclined section and covering a surface of the first color film. The extending section of the capacitor electrode can extend from an end A of the lateral section or from an end B of the lateral section, or can extend from both the ends A and B of the lateral section.

The lateral section 6 of the capacitor electrode 5 and the common electrode 1 forms a sensing capacitor of the touch screen sensing device, which increases a pixel aperture ratio of the capacitive touch screen sensing device and further improves a display effect of the capacitive touch screen sensing device.

Furthermore, the COA structure further includes a pixel area arranged in parallel with the TFT. The surface of the pixel area is provided with a pixel electrode which is electrically disconnected from the capacitor electrode. A storage capacitor is configured on the TFT-side substrate, and a pole of the storage capacitor is electrically connected to the pixel electrode. The capacitor electrode is electrically disconnected from the pixel electrode, which prevents the storage capacitor from being influenced in the touch operation and further improves the display effect of the touch screen sensing device.

Furthermore, the common electrode is coated on another glass substrate and liquid crystals (not shown) are ejected into a space defined between the common electrode and the protruding section of the capacitor electrode to form a liquid crystal layer. Light from a backlight source (not shown) enters into the liquid crystal layer between the common electrode and the pixel area after passing through the pixel area and thereafter emits out of the liquid crystal layer through the common electrode.

Furthermore, in order to provide good insulation between the capacitor electrode and the common electrode, the insulating layer is preferably made of SiNx. In other embodiments, the insulating layer can be made of other suitable material.

Furthermore, in order to reduce the influence on the light transmittance of the touch screen sensing device, the capacitor electrode is preferably made of transparent conductive material such as indium tin oxide (ITO) or indium zinc oxide (IZO). In other embodiments, the capacitor electrode can be made of other suitable conductive material.

The present disclosure further provides a touch screen sensing assembly which includes a backlight module and a touch screen sensing device. The touch screen sensing device includes a common electrode and a COA structure. The common electrode is located above the COA structure. The COA structure includes a TFT and a multilayer color film configured on the TFT. The common electrode corresponds to an upper portion of the multilayer color film. A capacitor electrode is configured between the common electrode and the COA structure. The capacitor electrode includes a lateral section located on the upper portion of the multilayer color film and an extending portion extending from one end of the lateral section and covering a side portion of the multilayer color film. A spacer is formed between the lateral section of the capacitor electrode and COA structure to space the lateral section from the capacitor electrode. Light from the backlight module emits out after passing through the touch screen sensing device.

The touch screen sensing device of the touch screen sensing assembly is the same as the touch screen sensing device described above, and the structure of the touch screen sensing device and the method for manufacturing the touch screen sensing device can be referred to those of the touch screen sensing device described above, which is not given in detail herein anymore. Compared to the conventional touch screen sensing assembly, the sensing capacitor of the touch screen sensing assembly with the above touch screen sensing device is formed by the lateral section of the capacitor electrode and the common electrode, which increases the pixel aperture ratio of the capacitive touch screen sensing device and further improves the display effect of the capacitive touch screen sensing device.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A touch screen sensing device, comprising:
a COA structure comprising a TFT and a multilayer color film configured on the TFT;
a common electrode located above the COA structure and corresponding to an upper portion of the multilayer color film;
a capacitor electrode configured between the common electrode and the COA structure, comprising a lateral section located on the upper portion of the multilayer color film and an extending section extending from one end of the lateral section and covering a side portion of the multilayer color film; and
a spacer formed between the common electrode and the COA structure to space the lateral section from the capacitor electrode.

2. The touch screen sensing device of claim 1, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

3. The touch screen sensing device of claim 1, wherein the COA structure further comprises a pixel area arranged in parallel with TFT; a surface of the pixel area is provided with a pixel electrode, and the pixel electrode is electrically disconnected from the capacitor electrode.

4. The touch screen sensing device of claim 1, wherein an insulating layer is arranged between the multilayer color film and the capacitor electrode.

5. The touch screen sensing device of claim 4, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

6. The touch screen sensing device of claim 5, wherein the COA structure further comprises a pixel area arranged in parallel with TFT; a surface of the pixel area is provided with a pixel electrode, and the pixel electrode is electrically disconnected from the capacitor electrode.

7. The touch screen sensing device of claim 1, wherein an insulating layer is arranged on the capacitor electrode.

8. The touch screen sensing device of claim 7, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

9. The touch screen sensing device of claim 8, wherein the COA structure further comprises a pixel area arranged in parallel with TFT; a surface of the pixel area is provided with a pixel electrode, and the pixel electrode is electrically disconnected from the capacitor electrode.

10. A method for manufacturing a touch screen sensing device with a COA structure which comprises a TFT and a multilayer color film configured on the TFT, comprising:
coating conductive material on a substrate with the COA structure formed thereon;
coating a photoresist on the conductive material and exposing the substrate with the photoresist coated thereon;
developing the exposed substrate and etching the developed substrate;
stripping the photoresist from the etched substrate and thus a capacitor electrode on the multilayer color film is formed wherein the capacitor electrode comprises a lateral section located between an upper portion of the multilayer color film and the common electrode and an extending portion extending from one end of the lateral section and covering a side portion of the multilayer color film;
coating optical spacing material on a substrate with a common electrode formed thereon; and
exposing the substrate with the optical spacing material coated thereon and developing the exposed substrate to form a spacer on the common electrode which spaces the lateral section from the capacitor electrode.

11. The method of claim 10, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

12. The method of claim 11, wherein the COA structure further comprises a pixel area arranged in parallel with TFT; a surface of the pixel area is provided with a pixel electrode, and the pixel electrode is electrically disconnected from the capacitor electrode.

13. The method of claim 10 further comprising the following step before the step of coating a photoresist on the conductive material and exposing the substrate with the photoresist coated thereon:
coating insulating material on the substrate with the conductive material coated thereon to form an insulating layer on the capacitor electrode; and
coating conductive material on the insulating layer.

14. The method of claim 13, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

15. The method of claim 14, wherein the COA structure comprises a pixel area arranged in parallel with TFT; a surface of the pixel area is provided with a pixel electrode, and the pixel electrode is electrically disconnected from the capacitor electrode.

16. The method of claim 10 further comprising the following step after the step of stripping the photoresist from the etched substrate and thus a capacitor electrode on the multilayer color film is formed wherein the capacitor electrode comprises a lateral section located between an upper portion of the multilayer color film and the common electrode and an extending portion extending from one end of the lateral section and covering a side portion of the multilayer color film:
coating insulating material on the substrate with the capacitor electrode formed thereon to form an insulating layer on the capacitor electrode.

17. The method of claim 16, wherein the multilayer color film comprises a first color film, a second color film, and a third color film overlaying on the TFT in sequence; the extending section comprises an inclined section and a protruding section, the inclined section corresponds to the third color film and the second color film, and the protruding section extends from the inclined section and covers a surface of the first color film.

18. The method of claim 17, wherein the COA structure comprises a pixel area arranged in parallel with TFT; a surface of the pixel area is provided with a pixel electrode, and the pixel electrode is electrically disconnected from the capacitor electrode.

19. A touch screen sensing assembly, comprising:
a touch screen sensing device, comprising:
a COA structure comprising a TFT and a multilayer color film configured on the TFT;
a common electrode located above the COA structure and corresponding to an upper portion of the multilayer color film;
a capacitor electrode configured between the common electrode and the COA structure, comprising a lateral section located on an upper portion of the multilayer color film and an extending from at least one end of the lateral section and covering a side portion of the multilayer color film; and
a spacer configured between the common electrode and the COA structure to space the lateral section from the capacitor electrode; and
a backlight module emitting light which emits out after passing through the touch screen sensing device.
